(19) United States
(12) Patent Application Publication
(10) Pub. No.: US 2021/0036376 A1
(43) Pub. Date: Feb. 4, 2021

(54) FLEXIBLE BATTERY, METHOD FOR MANUFACTURING THEREOF AND SUPPLEMENTARY BATTERY COMPRISING THE SAME

(71) Applicant: AMOGREENTECH CO., LTD., Gimpo-si, Gyeonggi-do (KR)

(72) Inventors: Hyeon Woo CHO, Cheonan-si, Chungcheongnam-do (KR); Ju Hee JANG, Uijeongbu-si, Gyeonggi-do (KR)

(73) Assignee: AMOGREENTECH CO., LTD., Gimpo-si, Gyeonggi-do (KR)

(21) Appl. No.: 17/043,829

(22) PCT Filed: Jun. 11, 2019
(86) PCT No.: PCT/KR2019/007006

§ 371 Date: Sep. 30, 2020

(30) Foreign Application Priority Data
Jun. 11, 2018 (KR) 10-2018-0066811

(51) Int. Cl. H01M 10/0585; H01M 10/46; H01M 4/1393; H01M 4/133; H01M 4/04

(52) U.S. Cl. CPC H01M 10/0585; H01M 10/46; H01M 2004/027; H01M 4/133; H01M 4/0471; H01M 4/1393

(57) ABSTRACT

A flexible battery and method for manufacturing a flexible battery in which an electrode assembly is encapsulated by an exterior material with an electrolyte. The flexible battery may be provided with an electrode assembly manufactured by forming a positive electrode mixture by coating and drying a composition for forming a positive electrode active material on part or all of at least one surface of a positive electrode current collector; vacuum drying the positive electrode current collector to manufacture a positive electrode; forming a negative electrode mixture by coating and drying a composition for forming a negative electrode active material on part or all of at least one surface of a negative electrode current collector; vacuum drying the negative electrode current collector to manufacture a negative electrode; and laminating by interposing a separator between the positive electrode and the negative electrode.

### CROSS REFERENCE TO RELATED APPLICATION

This application is a 35 U.S.C. 371 National Phase Entry Application from PCT/KR2019/007006, filed Jun. 11, 2019, designating the United States, which claims the benefit of Korean Patent Application No. 10-2018-0066811 filed on Jun. 11, 2018, the disclosures of which are incorporated herein by reference in their entireties.

### BACKGROUND

### 1. Field of the Invention

The present invention relates to a flexible battery, a method for manufacturing thereof and a supplementary battery comprising the same.

### 2. Discussion of Related Art

As the demands of consumers change due to digitization, high performance, etc. of electronic products, the situation is that the market demand is also changing the trend toward the development of power supple devices that have a thin profile, light weight and high capacity due to high energy density.

In order to satisfy the consumer demands, power supply devices such as high energy-density and high-capacity lithium-ion secondary batteries, lithium-ion polymer batteries, supercapacitors (electric double layer capacitors), pseudo capacitors and the like are currently being developed.

In recent years, the demand for mobile electronic devices such as mobile phones, laptops, digital cameras and the like is continuously increasing, and in particular, an interest in flexible mobile electronic devices, to which rollable displays, flexible e-paper, flexible liquid crystal display (flexible LCD), flexible organic light-emitting diode (flexible-OLED) and the like are applied, has increased recently. Accordingly, it is also required that power supply devices for flexible mobile electronic devices have a flexible characteristic.

A flexible battery has been developed as one type of power supply devices that can reflect this characteristic.

The flexible battery may be a nickel-cadmium battery, a nickel-metal hydride battery, a nickel-hydrogen battery, a lithium-ion battery and the like, which have a flexible characteristic. In particular, the lithium-ion battery has high utility because it has a higher energy density per unit weight and can be charged quickly compared to other batteries such as a lead-acid battery, a nickel-cadmium battery, a nickel-hydrogen battery, a nickel-zinc battery and the like.

The lithium-ion battery uses a liquid electrolyte and has been mainly used in a welded form using a metal can as a container. However, since a cylindrical lithium-ion battery using the metal can as a container has a fixed shape, it has a disadvantage that the design of an electronic product is limited, and it is difficult to reduce the volume.

In particular, as mentioned above, mobile electronic devices are not only developed to be thinned and small-sized, but also to be flexible such that there is a problem where previous lithium-ion batteries using a metal can and batteries having a rectangular structure cannot be easily applied to the mobile electronic devices as above.

Accordingly, in order to solve the above structural problem, pouch-type batteries have been developed recently, in which an electrolyte is placed into a pouch including two electrodes and a separator to be used by sealing.

Such pouch-type batteries are made of a flexible material and can be manufactured in various forms, and have an advantage that a high energy density per mass can be implemented.

Recently, there are cases in which previous pouch-type batteries as above are implemented in a flexible form in products. However, for pouch-type batteries that are commercialized or under development until now, if repeated bending occurs while in use, the exterior material and the electrode assembly are damaged due to repetitive contraction and relaxation, or the performance is significantly reduced compared to the originally designed value, and thus, there is a limitation in exerting the function as a battery. Also, there is a problem that ignition and/or explosion occur due to a contact between the negative electrode and the positive electrode because of damage or a low melting point, and there is a problem that the ion exchange of an electrolyte inside the battery is not easy.

### SUMMARY OF THE INVENTION

The present invention has been devised to solve the above problems and is directed to providing a method for manufacturing a flexible battery in which cracks and/or peeling of an active material do not occur when patterns are formed as the back spring phenomenon is suppressed, and accordingly, performance reduction due to a decrease in capacity, an increase in resistance, an internal short circuit and the like does not occur.

In addition, the present invention can prevent the occurrence of cracks even when bending occurs through a predetermined pattern formed in an electrode assembly, and the present invention is also directed to providing a flexible battery and a supplementary battery including the same that can prevent or minimize the deterioration of physical characteristics that a battery is required to exhibit, even if repeated bending occurs.

In order to solve the above problems, in the present invention, with respect to the manufacturing method of a flexible battery in which an electrode assembly is encapsulated by an external material with an electrolyte, the electrode assembly is manufactured by including the steps of forming a positive electrode mixture by coating and drying a composition for forming a positive electrode active material on part or all of at least one surface of a positive electrode current collector; vacuum drying the positive electrode current collector to manufacture a positive electrode; forming a negative electrode mixture by coating and drying a composition for forming a negative electrode active material on part or all of at least one surface of a negative electrode current collector; vacuum drying the negative electrode current collector to manufacture a negative electrode; and laminating by interposing a separator between the positive electrode and the negative electrode, wherein the positive electrode mixture has a back spring calculated according to Mathematical Formula 1 below of 3.5% or less, wherein the negative electrode mixture has a back spring calculated according to Mathematical Formula 2 below of 4.5% or less:

Back spring (%)=((layer thickness of a positive electrode mixture after vacuum drying(μm)/layer thickness of a positive electrode mixture before vacuum drying(μm))−1)×100(%) [Mathematical Formula 1]

Back spring (%)=((layer thickness of a negative electrode mixture after vacuum drying (μm)/layer thickness of a negative electrode mixture before vacuum drying (μm))−1)×100(%) [Mathematical Formula 2]

According to an exemplary embodiment of the present invention, the composition for forming a positive electrode active material may have a solid content of 60 to 90% by weight, wherein vacuum drying of the positive electrode current collector may be performed at a temperature of 90 to 170° C. for 8 to 16 hours.

In addition, the composition for forming a positive electrode active material may include 0.5 to 1.5 parts by weight of a first conductive material, 0.1 to 1 part by weight of a second conductive material and 1 to 4 parts by weight of PVDF based on 100 parts by weight of a positive electrode material.

In addition, the composition for forming a negative electrode active material may have a solid content of 30 to 65% by weight, wherein the vacuum drying of a negative electrode current collector provided with a negative electrode mixture formed on part or all of at least one surface thereof may be performed at a temperature of 60 to 140° C. for 8 to 16 hours.

In addition, the composition for forming a negative electrode active material may include 0.55 to 1.6 parts by weight of a first conductive material and 2.5 to 9 parts by weight of PVDF based on 100 parts by weight of a negative electrode material.

In addition, the first conductive material may include spherical carbon black, and the second conductive material may include graphite.

In addition, the first conductive material may include spherical carbon black.

In addition, forming a pattern for contraction and relaxation in a longitudinal direction when bending may be further included.

Meanwhile, the present invention provides a flexible battery, including an electrode assembly provided with a positive electrode in which a positive electrode active material is coated on part or all of at least one surface of a positive electrode current collector, a negative electrode in which a negative electrode active material is coated on part or all of at least one surface of a negative electrode current collector, and a separator disposed between the positive electrode and the negative electrode; an electrolyte; and an exterior material encapsulating the electrode assembly with the electrolyte, wherein the negative electrode active material has a moisture content of 200 ppm or less, wherein the positive electrode active material has a moisture content of 500 ppm or less.

According to an exemplary embodiment of the present invention, resistance fluctuation rate measured by Measurement Method 1 below may be 5% or less.

[Measurement Method 1]

In a fully charged flexible battery, resistance is measured by bending in a longitudinal direction of the battery and bending in the opposite direction, and then the resistance fluctuation rate is measured against resistance before bending.

In addition, the positive electrode active material may have a layer thickness of 40 to 60 μm, and the negative electrode active material may have a layer thickness of 50 to 75 μm.

In addition, the positive electrode active material may be formed by a composition for forming a positive electrode active material including a positive electrode material, a first conductive material, a second conductive material and PVDF, wherein the positive electrode material may have an average particle diameter of 3 to 20 μm.

In addition, the negative electrode active material may be formed by a composition for forming a negative electrode active material including a negative electrode material, a first conductive material and PVDF, wherein the negative electrode material may have an average particle diameter of 8 to 40 μm.

In addition, the electrode assembly may include a pattern for contraction and relaxation in a longitudinal direction when bending.

Meanwhile, the present invention provides a supplementary battery, including the aforementioned flexible battery; and a soft housing covering the surface of the exterior material, wherein the housing is provided with at least one terminal portion for electrical connection with a device to be charged.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a process flowchart of manufacturing an electrode assembly provided in a flexible battery according to an exemplary embodiment of the present invention;

FIG. 2 is an enlarged view illustrating a detailed configuration of a flexible battery according to an exemplary embodiment of the present invention;

FIG. 3 is an overall schematic diagram illustrating a flexible battery according to an exemplary embodiment of the present invention;

FIG. 4 is an overall schematic diagram illustrating a flexible battery according to another exemplary embodiment of the present invention, and it is a diagram illustrating a case in which a first pattern is formed only on the side of the accommodating portion of an exterior material;

FIG. 5 is a schematic diagram illustrating a form in which a flexible battery according to an exemplary embodiment of the present invention is embedded in a housing and implemented as a supplementary battery;

FIG. 6A is an image of a positive electrode active material according to an exemplary embodiment of the present invention, and FIG. 6B is an image of a positive electrode active material in which cracks are generated, which does not satisfy an exemplary embodiment of the present invention; and

FIG. 7A is an image of a negative electrode active material according to an exemplary embodiment of the present invention, and FIG. 7B is an image of a negative electrode active material in which cracks are generated, which does not satisfy an exemplary embodiment of the present invention.

### DETAILED DESCRIPTION OF EXEMPLARY EMBODIMENTS

Hereinafter, exemplary embodiments of the present invention will be described in detail to be embodied by those skilled in the art with reference to the accompanying drawings. The present invention may be implemented in various forms and is not limited to the following exemplary embodiments. In the drawings, parts irrelevant to the description are omitted in order to clearly describe the present invention, and the same reference numerals are added to the same or similar components throughout the entire specification.

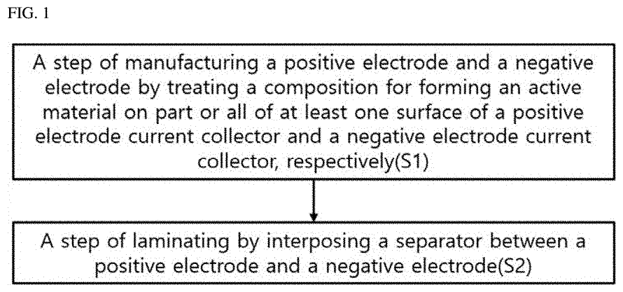

A flexible battery according to an exemplary embodiment of the present invention, as illustrated in FIG. 1, is manufactured by being provided with an electrode assembly, which is manufactured by including the steps of manufacturing a positive electrode and a negative electrode by treating a composition for forming an active material on part or all of at least one surface of a positive electrode current collector and a negative electrode current collector, respectively, and laminating by interposing a separator between the positive electrode and the negative electrode.

Specifically, the electrode assembly is manufactured by including the steps of forming a positive electrode mixture by coating and drying a composition for forming a positive electrode active material on part or all of at least one surface of a positive electrode current collector; vacuum drying the positive electrode current collector provided with the positive electrode mixture formed on part or all of at least one surface thereof to manufacture a positive electrode; forming a negative electrode mixture by coating and drying a composition for forming a negative electrode active material on part or all of at least one surface of a negative electrode current collector; vacuum drying the negative electrode current collector provided with the negative electrode mixture formed on part or all of at least one surface thereof to manufacture a negative electrode; and laminating by interposing a separator between the positive electrode and the negative electrode.

First, the step of forming a positive electrode mixture by coating and drying a composition for forming a positive electrode active material on part or all of at least one surface of a positive electrode current collector will be described.

The positive electrode current collector may be used without limitation as long as it is a material that is commonly used in the art as a positive electrode current collector of a flexible battery, and preferably, aluminum (Al) may be used. In addition, the positive electrode current collector may have a thickness of 10 to 30 μm, and preferably, a thickness of 15 to 25 μm.

The composition for forming a positive electrode active material may have a solid content of 60 to 90% by weight, and preferably, the solid content may be 65 to 85% by weight. If the solid content of the composition for forming a positive electrode active material is less than 60% by weight, a back spring phenomenon may occur after vacuum drying of the electrode, and cracks may be generated in the electrode during the molding process of a flexible battery. If it is more than 90% by weight, since a non-uniform coating may be formed on the positive electrode current collector due to the high viscosity of the composition, durability against bending may deteriorate. Meanwhile, the composition for forming a positive electrode active material may include a positive electrode material, a first conductive material, a second conductive material and PVDF.

The positive electrode material may be used without limitation as long as it is a positive electrode material that is commonly used in the art, and preferably, any one of a lithium-transition metal oxide such as LiCoO₂, LiNiO₂, LiNiCoO₂, LiMnO₂, LiMn₂O₄, V₂O₅, V₆O₁₃, LiNi_{1-xy}CoₓM_{y}O₂ (0≤≤x≤≤1, 0≤≤y≤≤1, 0≤≤x+y≤≤1, M is a metal such as Al, Sr, Mg, La, etc.) and a lithium nickel cobalt manganese (NCM)-based active material may be used, and a mixture of one or more thereof mixed therein may be used.

In addition, the positive electrode material may have an average particle diameter of 3 to 20 μm, and preferably, the average particle diameter may be 5 to 15 μm. If the average particle diameter of the positive electrode material is less than 3 μm, dispersion unevenness or moisture management of the composition may be difficult due to a phenomenon in which positive electrode materials aggregate, and if it is more than 20 μm, cracks of the electrode may be generated during the molding process or bending of a flexible battery.

The first conductive material may be used without limitation as long as it is a conductive material that is commonly used in the art, and preferably, it may include spherical carbon black. The first conductive material may be included at 0.5 to 1.5 parts by weight, and preferably, 0.6 to 1.4 parts by weight based on 100 parts by weight of the positive electrode material. If the first conductive material is included at less than 0.5 parts by weight based on 100 parts by weight of the positive electrode material, the resistance of a battery may increase, and if it is more than 1.5 parts by weight, the capacity of a battery may be reduced.

In addition, the second conductive material may be used without limitation as long as it is a conductive material that is commonly used in the art, and preferably, it may include graphite. The second conductive material may be included at 0.1 to 1 part by weight, and preferably, 0.2 to 0.9 parts by weight based on 100 parts by weight of the positive electrode material. If the second conductive material is included at less than 0.1 parts by weight based on 100 parts by weight of the positive electrode material, the resistance of a battery may increase, and if it is more than 1 part by weight, the capacity of a battery may be reduced.

In addition, the PVDF functions as a binder between an active material, a conductive material and a current collector, and may be included at 1 to 4 parts by weight, and preferably, 1.5 to 3.5 parts by weight based on 100 parts by weight of the positive electrode material. If the PVDF is included at less than 1 part by weight based on 100 parts by weight of the positive electrode material, the composite material may be peeled off due to insufficient binding force, and if it is more than 4 parts by weight, the capacity of a battery may be reduced.

Meanwhile, the composition for forming a positive electrode active material may have a viscosity of 7,000 to 17,000 cps at 25° C., and preferably, the viscosity may be 8,000 to 16,000 cps at 25° C. If the viscosity of the composition for forming a positive electrode active material is less than 7,000 cps at 25° C., it may spread out of the coating area due to the flowability of a composition, and if it is more than 17,000 cps, the thickness may not be uniform during coating.

Meanwhile, the composition for forming a positive electrode active material may be coated by being pressed, deposited or applied to a positive electrode current collector, but is not limited thereto.

In addition, drying of the composition for forming a positive electrode active material may be performed at 120 to 180° C. for 0.3 to 3 minutes, but is not limited thereto.

Next, the step of vacuum drying the positive electrode current collector provided with a positive electrode mixture formed on part or all of at least one surface thereof to manufacture a positive electrode will be described.

The vacuum drying is not limited as long as it is a conventional vacuum drying condition for manufacturing a positive electrode, and it may be performed at a temperature of 90 to 170° C. for 8 to 16 hours, and more preferably, at 100 to 160° C. for 9 to 15 hours. If the vacuum drying temperature is less than 90° C. or the vacuum drying time is less than 8 hours, gas may be generated in the battery, the resistance may increase, and the capacity may be reduced due to excessive moisture. If the vacuum drying temperature is more than 170° C. or the vacuum drying time is more than 16 hours, back spring may occur such that cracks and/or peeling of a positive electrode active material may occur during pattern formation.

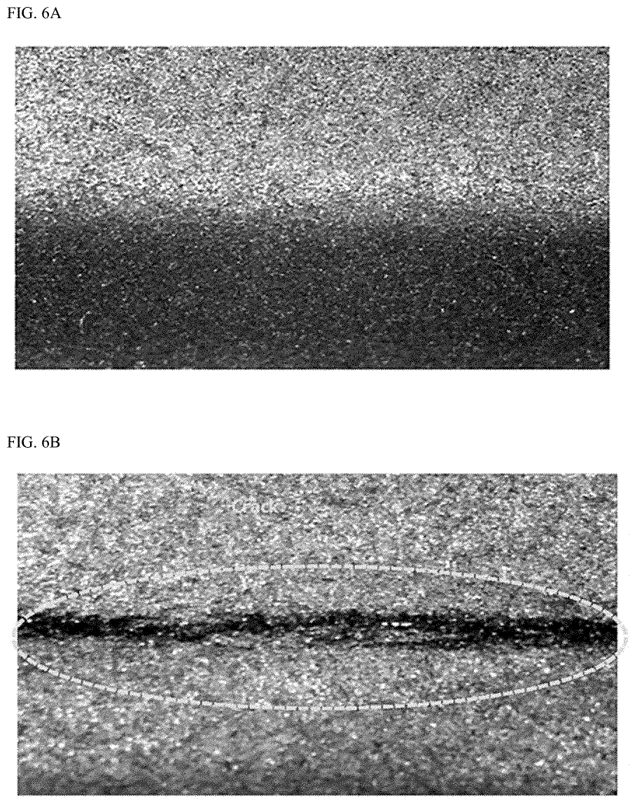

Meanwhile, as shown in FIG. 6A, in order that the positive electrode mixture may not have cracks and/or peeling occurring in the positive electrode active material during pattern formation, the back spring calculated according to Mathematical Formula 1 below may be 3.5% or less, preferably, 2.5% or less, and more preferably, 2.0% or less.

Back spring (%)=((layer thickness of a positive electrode mixture after vacuum drying (μm)/layer thickness of the positive electrode mixture before vacuum drying (μm))−1)×100(%) [Mathematical Formula 1]

If the back spring calculated according to Mathematical Formula 1 above is more than 3.5%, cracks and/or peeling of the positive electrode active material may occur during pattern formation as shown in FIG. 6B.

Next, the step of forming a negative electrode mixture by coating and drying a composition for forming a negative electrode active material on part or all of at least one surface of a negative electrode current collector will be described.

The negative electrode current collector may be used without limitation as long as it is a material that is commonly used in the art as a negative electrode current collector of a flexible battery, and preferably, copper (Cu) may be used. In addition, the negative electrode current collector may have a thickness of 3 to 18 μm, and preferably, a thickness of 6 to 15 μm.

The composition for forming a negative electrode active material may have a solid content of 30 to 65% by weight, and preferably, the solid content may be 35 to 60% by weight. If the solid content of the composition for forming a negative electrode active material is less than 30% by weight, a back spring phenomenon may occur after vacuum drying, and cracks may be generated in the electrode during the molding process of a flexible battery. If it is more than 65% by weight, since a non-uniform coating may be formed on the electrode current collector due to the high viscosity of the composition, durability against bending may deteriorate.

Meanwhile, the composition for forming a negative electrode active material may include a negative electrode material, a first conductive material and PVDF.

The negative electrode material may be used without limitation as long as it is a negative electrode material that is commonly used in the art, and preferably, it may be selected from the group consisting of crystalline or amorphous carbon, carbon fiber, or a carbon-based negative electrode active material of a carbon composite, tin oxide, the lithiated product thereof, lithium, a lithium alloy and a mixture of one or more thereof mixed therein. Herein, carbon may be one or more selected from the group consisting of a carbon nanotube, a carbon nanowire, a carbon nanofiber, artificial graphite, black lead, activated carbon, graphene and graphite.

In addition, the negative electrode material may have an average particle diameter of 8 to 40 μm, and preferably, the average particle diameter may be 15 to 30 μm. If the average particle diameter of the negative electrode material is less than 8 μm, dispersion unevenness or moisture management of the composition may be difficult due to a phenomenon in which positive electrode materials aggregate, and if it is more than 40 μm, cracks of the electrode may be generated during the molding process or bending of a flexible battery.

The first conductive material may be used without limitation as long as it is a conductive material that is commonly used in the art, and preferably, it may include spherical carbon black. The first conductive material may be included at 0.55 to 1.6 parts by weight, and preferably, at 0.65 to 1.5 parts by weight based on 100 parts by weight of the negative electrode material. If the first conductive material is included at less than 0.55 parts by weight based on 100 parts by weight of the negative electrode material, the resistance of a battery may increase, and if it is more than 1.6 parts by weight, the capacity of a battery may be reduced.

In addition, the PVDF functions as a binder between the active material, the conductive material and the current collector, and may be included at 2.5 to 9 parts by weight, and preferably, 3.5 to 8 parts by weight based on 100 parts by weight of the negative electrode material. If the PVDF is included at less than 2.5 parts by weight based on 100 parts by weight of the negative electrode material, the composite material may be peeled off due to insufficient binding force, and if it is more than 9 parts by weight, resistance may increase, or the capacity of a battery may be reduced.

Meanwhile, the composition for forming a negative electrode active material may have a viscosity of 5,000 to 15,000 cps at 25° C., and preferably, the viscosity may be 6,000 to 14,000 cps at 25° C. If the viscosity of the composition for forming a negative electrode active material is less than 5,000 cps at 25° C., it may spread out of the coating area due to the flowability of the composition, and if it is more than 15,000 cps, the thickness may not be uniform during coating.

Meanwhile, the composition for forming a negative electrode active material may be coated by being pressed, deposited or applied to the negative electrode current collector, but is not limited thereto.

In addition, drying of the composition for forming a negative electrode active material may be performed at 120 to 180° C. for 0.3 to 3 minutes, but is not limited thereto.

Next, the step of vacuum drying a negative electrode current collector provided with a negative electrode mixture formed on part or all of at least one surface thereof to manufacture a negative electrode will be described.

The vacuum drying is not limited as long as it is a conventional vacuum drying condition for manufacturing a negative electrode, and it may be performed at a temperature of 60 to 140° C. for 8 to 16 hours, and more preferably, at 70 to 130° C. for 9 to 15 hours. If the temperature of the vacuum drying is less than 60° C. or the vacuum drying time is less than 8 hours, gas may be generated in the battery, the resistance may increase, and the capacity may be reduced due to excessive moisture. If the temperature of the vacuum drying is more than 140° C. or the vacuum drying time is more than 16 hours, back spring may occur such that cracks and/or peeling of a negative electrode active material may occur during pattern formation.

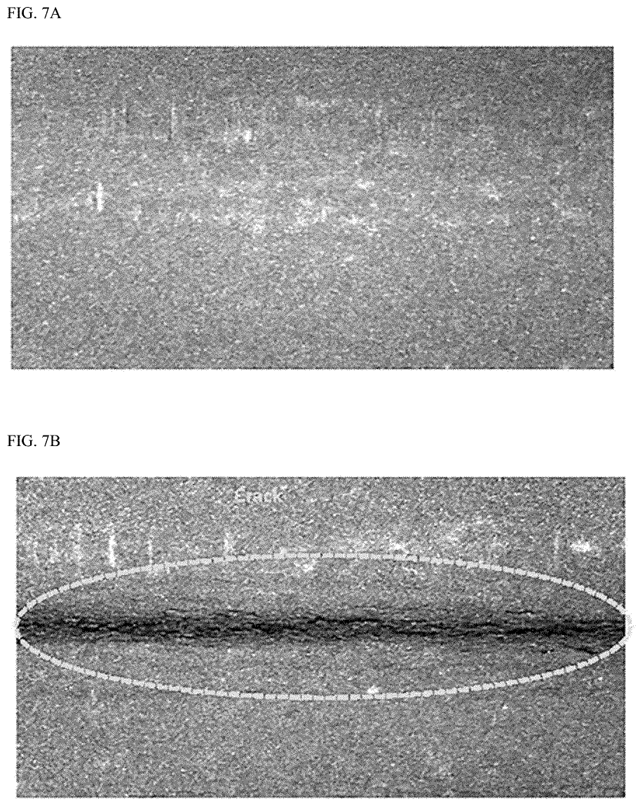

Meanwhile, as shown in FIG. 7A, in order that cracks and/or peeling of the negative electrode active material may not occur during pattern formation, the negative electrode mixture may have a back spring calculated according to Mathematical Formula 2 below of 4.5% or less, preferably, 3.5% or less, and more preferably, 3.0% or less.

Back spring (%)=((layer thickness of a negative electrode mixture after vacuum drying (μm)/layer thickness of a negative electrode mixture before vacuum drying (μm))−1)×100(%) [Mathematical Formula 2]

If the back spring calculated according to Mathematical Formula 2 above is more than 4.5%, cracks and/or peeling of the negative electrode active material may occur during pattern formation as shown in FIG. 7B.

Next, the step of laminating by interposing a separator between the positive electrode and the negative electrode will be described.

The separator is not particular limited in the present invention, as it may be laminated by interposing a separator to be disposed between the positive electrode and the negative electrode according to a method commonly used in the art.

Meanwhile, the manufacturing method for a flexible battery according to the present invention may further include a step of forming a pattern for contraction and relaxation in a longitudinal direction when bending the electrode assembly.

Such a pattern prevents or minimizes contraction or relaxation of a substrate itself by offsetting the amount of change in length caused by the change in curvature at the bent portion when bending the flexible battery.

Through this, even if repeated bending occurs, since the amount of deformation of the substrate itself constituting the electrode assembly, which may occur locally at the bent portion, is minimized, it is possible to prevent the electrode assembly from being locally damaged or deteriorating in performance by bending.

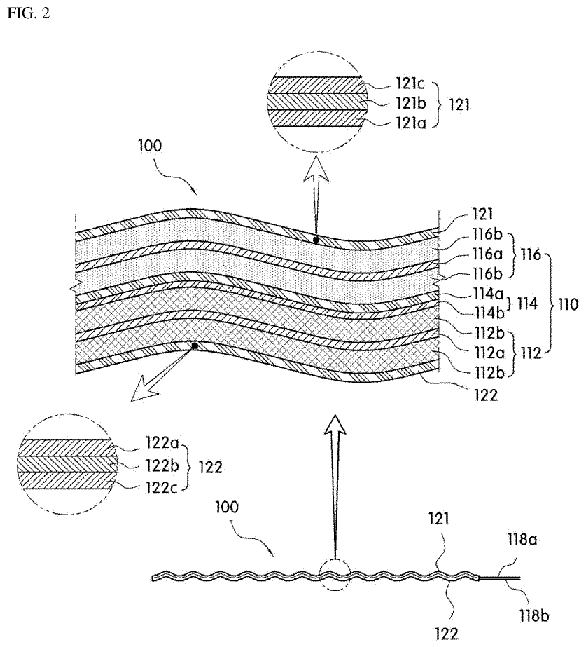

Meanwhile, as illustrated in FIG. 2, the flexible battery 100 according to an exemplary embodiment of the present invention includes an electrode assembly 110 provided with a positive electrode 112 provided with a positive electrode current collector 112a in which a positive electrode active material 112b is coated on part or all of at least one surface thereof, a negative electrode 116 provided with a negative electrode current collector 116a in which a negative electrode active material 116b is coated on part or all of at least one surface thereof, and a separator 114 disposed between the positive electrode 112 and the negative electrode 116; an electrolyte; and an exterior material 120 encapsulating the electrode assembly 110 with the electrolyte.

First, the electrode assembly 110 will be described.

In the description of the electrode assembly, it will be described by omitting the same parts as those described above.

The electrode assembly 110 is encapsulated with an electrolyte inside an exterior material 120 to be described below, and includes a positive electrode 112, a negative electrode 116 and a separator 114 as illustrated in FIG. 2.

The positive electrode 112 includes a positive electrode current collector 112a and a positive electrode active material 112b, and the negative electrode 116 includes a negative electrode current collector 116a and a negative electrode active material 116b. The positive electrode current collector 112a and the negative electrode current collector 116a may be implemented in the form of a plate-shaped sheet having a predetermined area.

Meanwhile, the positive electrode active material 112b may have a moisture content of 500 ppm or less, preferably, the moisture content may be 450 ppm or less, and more preferably, the moisture content may be 350 ppm or less. If the moisture content of the positive electrode active material 112b is more than 500 ppm, problems such as generation of gas in the battery, an increase in resistance and a decrease in capacity may occur due to excessive moisture.

In addition, the positive electrode active material 112b may have a layer thickness of 40 to 60 μm, and preferably, the layer thickness may be 45 to 55 μm. If the layer thickness of the positive electrode active material 112b is less than 45 μm, the energy density of a battery may decrease, and if the layer thickness is more than 60 μm, cracks of the electrode may be generated during the molding process or bending of a flexible battery.

Meanwhile, the negative electrode active material 116b may have a moisture content of 200 ppm or less, preferably, the moisture content may be 150 ppm or less, and more preferably, the moisture content may be 100 ppm or less. If the moisture content of the negative electrode active material 116b is more than 200 ppm, problems such as generation of gas in the battery, an increase in resistance and a decrease in capacity may occur due to excessive moisture.

In addition, the negative electrode active material 116b may have a layer thickness of 50 to 75 μm, and preferably, the layer thickness may be 55 to 70 μm. If the layer thickness of the negative electrode active material 116b is less than 50 μm, the energy density of a battery may decrease, and if the layer thickness is more than 75 μm, cracks of the electrode may be generated during the molding process or bending of a flexible battery.

In addition, as illustrated in FIGS. 2 to 4, the positive electrode current collector 112a and the negative electrode current collector 116a may be formed with a negative electrode terminal 118a and a positive electrode terminal 118b for electrical connection from each body to an external device, respectively. Herein, the positive electrode terminal 118b and the negative electrode terminal 118a may be provided to extend from the positive electrode current collector 112a and the negative electrode current collector 116a so as to protrude to one side of the exterior material 120, and so as to be exposed on the surface of the exterior material.

Meanwhile, in the present invention, the positive electrode active material 112b and the negative electrode active material 116b may contain a polytetrafluoroethylene (PTFE) component. This is to prevent the positive electrode active material 112b and the negative electrode active material 116b from being peeled off from the current collectors 112a and 116a, respectively, or cracks from being generated.

Such a PTFE component may be 0.5 to 20% by weight based on the total weight of each of the positive electrode active material 112b and the negative electrode active material 116b, and preferably, 5% by weight or less.

Meanwhile, a separator 114 disposed between the positive electrode 112 and the negative electrode 116 may include a nanofiber web layer 114b on one surface or both surfaces of a non-woven fabric layer 114a.

Herein, the nanofiber web layer 114b may be a nanofiber containing one or more selected from a polyacrylonitrile nanofiber and a polyvinylidene fluoride nanofiber.

Preferably, the nanofiber web layer 114b may be composed only of a polyacrylonitrile nanofiber to ensure spinnability and uniform pore formation. Herein, the polyacrylonitrile nanofiber may have an average diameter of 0.1 to 2 μm, and preferably, 0.1 to 1.0 μm.

This is because if the average diameter of the polyacrylonitrile nanofiber is less than 0.1 μm, there is a problem that the separator may not secure sufficient heat resistance, and if it is more than 2 μm, the mechanical strength of a separator may be excellent, but the elasticity of a separator membrane may rather decrease.

In addition, when a gel polymer electrolyte is used as the electrolyte, a composite porous separator may be used for the separator 114 to optimize the impregnability of the gel polymer electrolyte.

That is, the composite porous separator may be used as a matrix and may include a porous non-woven fabric having micropores and a porous nanofiber web formed of a spinnable polymer material impregnated with an electrolyte.

Herein, the porous non-woven fabric may be composed of a PP non-woven fabric, a PE non-woven fabric and a non-woven fabric made of a PP/PE fiber having a dual structure coated with PE on the outer circumference of the PP fiber as a core, and a triple structure of PP/PE/PP, and may use any one of a non-woven fabric having a shutdown function by PE having a relatively low melting point, a PET non-woven fabric made of a polyethylene terephthalate (PET) fiber, or a non-woven fabric made of a cellulose fiber. In addition, the PE non-woven fabric may have a melting point of 100 to 120° C., the PP non-woven fabric may have a melting point of 130 to 150° C., and the PET non-woven fabric may have a melting point of 230 to 250° C.

In this case, in the porous non-woven fabric, a thickness may be set in a range of 10 to 40 μm, a porosity may be set to 5 to 55%, and a Gurley value may be set to 1 to 1,000 sec/100 c.

Meanwhile, the porous nanofiber web may use a swellable polymer, which is swelled in the electrolyte alone, or use a mixed polymer in which the swellable polymer is mixed with a heat-resistant polymer capable of reinforcing heat resistance.

As such, the porous nanofiber web is formed by dissolving a single or mixed polymer in a solvent to form a spinning solution, spinning a spinning solution by an electrospinning device to accumulate the spun nanofiber in a collector to have a 3D porous structure.

Herein, the porous nanofiber web may use any polymer capable of forming a nanofiber which is dissolved in the solvent to form a spinning solution and spun by an electrospinning method. For example, the polymer may be a single polymer or a mixed polymer and may use a swellable polymer, a non-swellable polymer, a heat-resistant polymer, a mixed polymer in which the swellable polymer and the non-swellable polymer are mixed, a mixed polymer in which the swellable polymer and the heat-resistant polymer are mixed, or the like.

In this case, when the porous nanofiber web uses a mixed polymer of the swellable polymer and the non-swellable polymer (alternatively, the heat-resistant polymer), the swellable polymer and the non-swellable polymer may be mixed at a weight ratio of 9:1 to 1:9 and, preferably, 8:2 to 5:5.

Conventionally, in the case of a non-swellable polymer, generally, many heat-resistant polymers are used, and as compared with the swellable polymer, a molecular weight is large and thus, a melting point is relatively high. Accordingly, the non-swellable polymer may be a heat-resistant polymer having a melting point of 180° C. or more, and the swellable polymer may be a resin having a melting point of 150° C. or less and, preferably, in a range of 100 to 150° C.

Meanwhile, the swellable polymer usable in the present invention is a resin which is swellable in the electrolyte and may be used as an ultrafine nanofiber by an electrospinning method.

For example, polyvinylidene fluoride (PVDF), poly(vinylidene fluoride-co-hexafluoropropylene), perfluoropolymer, polyvinyl chloride or polyvinylidene chloride and copolymers thereof, polyethylene glycol derivatives including polyethylene glycol dialkyl ether and polyethylene glycol dialkyl ester, polyoxides including poly(oxymethylene-oligo-oxyethylene), polyethylene oxide and polypropylene oxide, polyvinyl acetate, poly(vinylpyrrolidone-vinyl acetate), polystyrene and polyacrylonitrile copolymer including polystyrene acrylonitrile copolymer and polyacrylonitrile methyl methacrylate copolymer, a polymethyl methacrylate, a polymethyl methacrylate copolymer, and a mixture with at least one thereof mixed therein may be used as the swellable polymer.

In addition, the heat-resistant polymer or the non-swellable polymer may be dissolved in an organic solvent for electrospinning and slowly swelled or not swelled by the organic solvent included in an organic electrolyte compared to a swellable polymer, and a resin having a melting point of 180° C. or more may be used.

For example, aromatic polyesters such as polyacrylonitrile (PAN), polyamide, polyimide, polyamideimide, poly(meta-phenylene isophthalamide), polysulfone, polyether ketone, polyethylene terephthalate, polytrimethylene terephthalate, polyethylene naphthalate and the like, polyphosphazenes such as polytetrafluoroethylene, polydiphenoxyphospazene and poly {bis[2-(2-methoxyethoxy)phosphazene]}, a polyurethane copolymer including polyurethane and polyetherurethane, cellulose acetate, cellulose acetate butyrate, cellulose acetate propionate and the like may be used as the heat-resistant polymer or the non-swellable polymer.

Meanwhile, the non-woven fabric constituting the non-woven fabric layer 114a may use one or more selected from cellulose, cellulose acetate, polyvinyl alcohol (PVA), polysulfone, polyimide, polyetherimide, polyamide, polyethylene oxide (PEO), polyethylene (PE), polypropylene (PP), polyethylene terephthalate (PET), polyurethane (PU), polymethylmethacrylate (PMMA) and polyacrylonitrile.

Herein, the non-woven fabric layer may further include an inorganic additive, and the inorganic additive may include one or more selected from SiO, SnO, SnO₂, PbO₂, ZnO, P₂O₅, CuO, MoO, V₂O₅, B₂O₃, Si₃N₄, CeO₂, Mn₃O₄, Sn₂P₂O₇, Sn₂B₂O₅, Sn₂BPO₆, TiO₂, BaTiO₃, Li₂O, LiF, LiOH, Li₃N, BaO, Na₂O, Li₂CO₃, CaCO₃, LiAlO₂, SiO₂, Al₂O₃ and PTFE.

In addition, inorganic particles as the inorganic additive may have an average particle diameter of 10 to 50 nm, preferably, 10 to 30 nm, and more preferably, 10 to 20 nm.

Moreover, an average thickness of the separator may be 10 to 100 μm and preferably, 10 to 50 μm. When the average thickness of the separator is less than 10 μm, the separator is too thin and thus, the long-term durability of the separator may not be ensured due to repetitive bending and/or straightening of the battery, and when the average thickness of the separator is more than 100 μm, it is disadvantageous in the thinning of a flexible battery and thus, the separator may have an average thickness in the above range.

In addition, the non-woven fabric layer may have an average thickness of 10 to 30 μm and preferably, 15 to 30 μm, and the nanofiber web layer may have an average thickness of 1 to 5 μm.

The exterior material 120 is made of a plate-shaped member having a predetermined area, and is to protect the electrode assembly 110 from external forces by accommodating the electrode assembly 110 and an electrolyte therein.

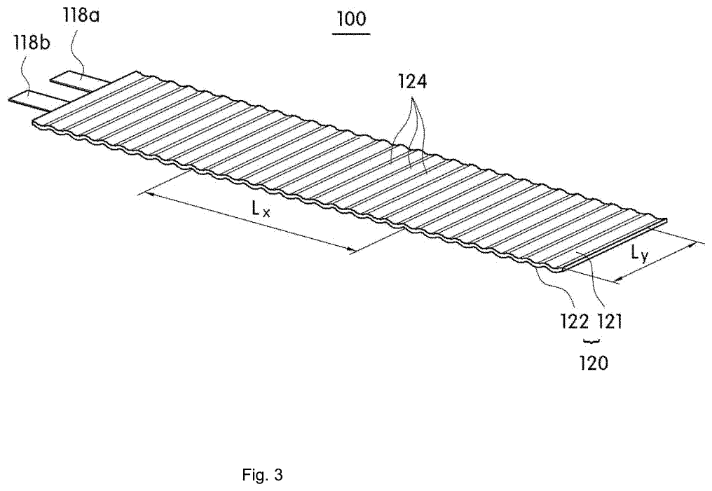

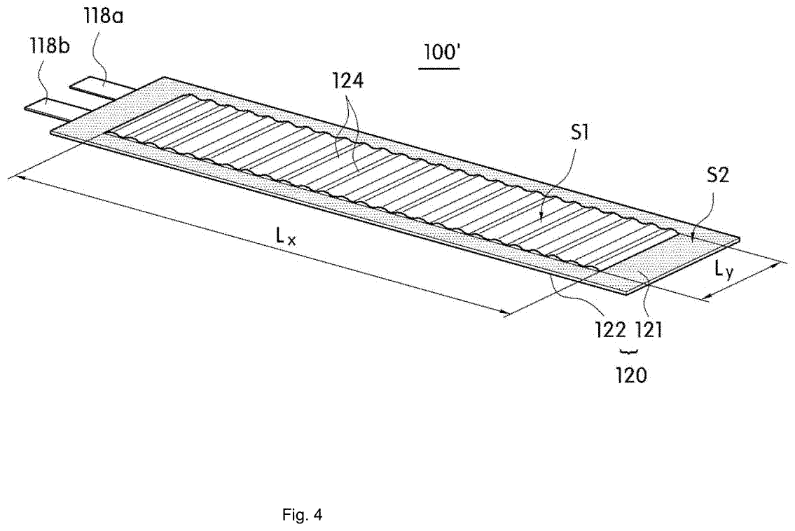

To this end, the exterior material 120 is provided with a pair of a first exterior material 121 and a second exterior material 122 as illustrated in FIGS. 3 and 4, and by being sealed with an adhesive along the edge, the electrolyte and the electrode assembly 110 accommodated therein are prevented from being exposed to the outside and leaking to the outside.

That is, the first exterior material 121 and the second exterior material 122 include a first area S1 forming an accommodating portion for accommodating an electrode assembly and an electrolyte, and a second area S2 disposed so as to surround the first area S1 to form a sealing part for blocking the leakage of an electrolyte to the outside.

In such an exterior material 120, the first exterior material 121 and the second exterior material 122 are formed of two members, and then all of the edges constituting the sealing part may be sealed with an adhesive, and after folding in half along the width direction or the length direction, the remaining part made of one member and in contact may be sealed with an adhesive.

In addition, the exterior material 120 may include a pattern 124 for contraction and relaxation along a longitudinal direction when bending, and as illustrated in FIG. 3, a pattern may be formed at all of the first area S1 and the second area S2, and preferably, the pattern 124 may be formed at only the first area S1, as illustrated in FIG. 4.

Meanwhile, for the details of the pattern according to the present invention, Korean Registered Patent No. 10-1680592 by the inventors of the present invention may be inserted as a reference to the present invention, and the detailed description thereof will be omitted herein.

In addition, when the exterior material 120 does not include a pattern, the exterior material 120 may use a polymer film having excellent waterproof properties, and in this case, a separate pattern may not be provided due to the flexible characteristics of a polymer film.

The exterior material 120 may be provided in a form in which metal layers 121b and 122b are interposed between first resin layers 121a and 122a and second resin layers 121c and 122c. That is, the exterior material 120 is constituted in a form in which the first resin layers 121a and 122a, the metal layers 121b and 122b and the second resin layers 121c and 122c are sequentially laminated, and the first resin layers 121a and 122a are disposed inside to contact an electrolyte, and the second resin layers 121c and 122c are exposed to the outside.

In this case, the first resin layers 121a and 122a serve as an adhesive member capable of preventing the electrolyte provided inside the battery from being leaked to the outside by sealing a space between the exterior materials 121 and 122. The first resin layers 121a and 122a may be a material of the adhesive member generally provided in the exterior material for a battery, but preferably, may include one single-layer structure or a laminated structure of acid modified polypropylene (PPa), casting polyprolypene (CPP), linear low density polyethylene (LLDPE), low density polyethylene (LDPE), high density polyethylene (HDPE), polyethylene, polyethylene terephthalate, polypropylene, ethylene vinyl acetate (EVA), epoxy resin and phenol resin, and preferably, it may be constituted by a single layer of any one selected from acid modified polypropylene (PPa), casting polypropylene (CPP), linear low density polyethylene (LLDPE), low density polyethylene (LDPE), and high density polyethylene (HDPE), or laminating at least two thereof.

In addition, the first resin layers 121a and 122a may have an average thickness of 20 μm to 100 μm and preferably, 20 μm to 80 μm.

The reason is that when the average thickness of the first resin layers 121a and 122a is less than 20 μm, it is disadvantageous in securing airtightness for preventing the adhesive strength between the first resin layers 121a and 122a contacting each other in a process of sealing the edge sides of the first exterior material 121 and the second exterior material 122 from being decreased or the electrolyte from being leaked, and when the average thickness is more than 100 μm, it is uneconomical and disadvantageous in thinning.

The metal layers 121b and 122b are interposed between the first resin layers 121a and 122a and the second resin layers 121c and 122c to prevent moisture from being penetrated to the side of the accommodating portion from the outside and prevent the electrolyte from being leaked from the accommodating portion to the outside.

To this end, the metal layers 121b and 122b may be formed of metal layers having a dense density to prevent moisture and the electrolyte from passing. The metal layer may be formed by a foil-type metal thin film or a metal deposition film formed on the second resin layers 121c and 122c to be described below by a general known method, for example, a method such as sputtering, chemical vapor deposition and the like and preferably, it may be formed in a metal thin film. Accordingly, cracks of the metal layer may be prevented when the patterns are formed to prevent the electrolyte from being leaked to the outside and the moisture from penetrating from the outside.

For example, the metal layers 121b and 122b may include one or more selected from aluminum, copper, phosphor bronze (PB), aluminum bronze, cupronickel, beryllium-copper, chromium-copper, titanium-copper, iron-copper, a Corson alloy and a chromium-zirconium copper alloy.

In this case, the metal layers 121b and 122b may have a linear expansion coefficient of 1.0×10⁻⁷ to 1.7×10⁻⁷/° C. and preferably, 1.2×10⁻⁷ to 1.5×10⁻⁷/° C. The reason is that when the linear expansion coefficient is less than 1.7×10⁻⁷/° C., sufficient flexibility may not be ensured and thus, cracks may be generated by external forces generated in the event of being bent, and when the linear expansion coefficient is more than 1.7×10⁻⁷/° C., stiffness is deteriorated and thus, the shape may be severely deformed.

As such, the metal layers 121b and 122b may have an average thickness of 5 μm or more, preferably, 5 μm to 100 μm and more preferably, 30 μm to 50 μm.

The reason is that when the average thickness of the metal layer is less than 5 μm, moisture may be penetrated into the accommodating portion or the electrolyte inside the accommodating portion may be leaked to the outside.

The second resin layers 121c and 122c may be positioned on an exposure surface of the exterior material 120 to reinforce strength of the exterior material and prevent damage to the exterior material such as scratches from being generated by a physical contact applied to the outside.

As such, the second resin layers 121c and 122c may include one or more selected from nylon, polyethylene terephthalate (PET), cycloolefin polymer (COP), polyimide (PI) and a fluorine-based compound and preferably, it may include nylon or a fluorine-based compound.

Herein, the fluorine-based compound may include one or more selected from polytetrafluoroethylene (PTFE), perfluorinated acid (PFA), a fluorinated ethylene propylene copolymer (FEP), polyethylene tetrafluoroethylene (ETFE), polyvinylidene fluoride (PVDF), ethylene chlorotrifluoroethylene (ECTFE) and polychlorotrifluoroethylene (PCTFE).

In this case, the second resin layers 121c and 122c may have an average thickness of 10 μm to 50 μm, preferably, 15 μm to 40 μm, and more preferably, 15 μm to 35 μm.

The reason is that when the average thickness of the second resin layers 121c and 122c is less than 10 μm, a mechanical property may not be ensured, and when the average thickness is more than 50 μm, it is advantageous in ensuring the mechanical property, but is uneconomical and disadvantageous in thinning.

Meanwhile, the flexible batteries 100 and 100′ according to the present invention may further include an adhesive layer between the metal layers 121b and 122b and the first resin layers 121a and 122a.

The adhesive layer serves to enhance an adhesive strength between the metal layers 121b and 122b and the first resin layers 121a and 122a and prevent the electrolyte accommodated inside the exterior material from reaching the metal layers 121b and 122b of the exterior material, thereby preventing the metal layers 121b and 122b from being corroded with an acidic electrolyte and/or the first resin layers 121a and 122a and the metal layers 121b and 122b from being peeled. In addition, while the flexible batteries 100 and 100′ are used, if problems such as overheating, etc. occur such that the flexible batteries are expanded, the electrolyte may be prevented from being leaked so as to give reliability in safety.

As such, the adhesive layer may be made of a similar material to the first resin layers 121a and 122a in order to improve the adhesive strength according to compatibility with the first resin layers 121a and 122a. For example, the adhesive layer may include one or more one selected from silicone, polyphthalate, acid-modified polypropylene (PPa), and acid-modified polyethylene (PEa).

In this case, the adhesive layer may have an average thickness of 5 μm to 30 μm and preferably, 10 μm to 20 μm. When the average thickness of the adhesive layer is less than 5 μm, it is difficult to ensure stable adhesion and when the average thickness is more than 30 μm, it is disadvantageous in thinning.

In addition, the flexible batteries 100 and 100′ according to the present invention may further include a dry laminate layer between the metal layers 121b and 122b and the second resin layers 121c and 122c.

The dry laminate layer serves to adhere the metal layers 121b and 122b to the second resin layers 121c and 122c and may be formed by drying a known aqueous and/or oily organic solvent-adhesive.

In this case, the dry laminate layer may have an average thickness of 1 μm to 7 μm, preferably, 2 μm to 5 μm, and more preferably, 2.5 μm to 3.5 μm.

The reason is that when the average thickness of the dry laminate layer is less than 1 μm, peeling between the metal layers 121b and 122b and the second resin layers 121c and 122c may occur because the adhesive strength is too weak, and when the average thickness is more than 7 μm, the thickness of the dry laminate layer is unnecessarily increased to have an adverse effect on forming patterns for contraction and relaxation.

Meanwhile, the electrolyte encapsulated in the accommodating portion together with the electrode assembly 110 may use a generally used liquid electrolyte.

For example, the electrolyte may use an organic electrolyte including a non-aqueous organic solvent and a solute of a lithium salt. Herein, carbonate, ester, ether or ketone may be used as the non-aqueous organic solvent. Dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC) and the like may be used as the carbonate. Butyrolactone (BL), decanolide, valerolactone, mevalonolactone, caprolactone, n-methyl acetate, n-ethyl acetate, n-propyl acetate and the like may be used as the ester. Dibutyl ether, etc. may be used as the ether, and polymethyl vinyl ketone may be used as the ketone. However, the present invention is not limited by the type of non-aqueous organic solvents.

In addition, the electrolyte used in the present invention may include a lithium salt, and the lithium salt acts as a supply source of lithium ions in the battery to operate a basic lithium battery and for example, may include one or more selected from the group consisting of LiPF₆, LiBF₄, LiSbF₆, LiAsF₆, LiClO₄, LiCF₃SO₃, LiN(CF₃SO₂)₂, LiN(C₂F₅SO₂)₂, LiAlO₄, LiAlCl₄, LiN(CₓF₂ₓ₋₁SO₂)(CyF₂ₓ₊₁SO₂) (herein, x and y are rational numbers), and LiSO₃CF₃, or a mixture thereof.

In this case, the electrolyte used in the flexible batteries 100 and 100′ according to the present invention may use a general liquid electrolyte, but preferably a gel polymer electrolyte may be used to prevent gas leakage and liquid leakage which may be generated in the flexible battery provided with the liquid electrolyte in the event of being bent.

For the gel polymer electrolyte, a gel polymer electrolyte may be formed by gelling heat treatment of a non-aqueous organic solvent, a solute of lithium salts and an organic electrolyte including a monomer for gel polymer formation and a polymerization initiator. For the gel polymer electrolyte as the above, the organic electrolyte may be thermally treated alone, but monomers may be in-situ polymerized by applying heat treatment in a condition in which the organic electrolyte is impregnated in a separator provided inside a flexible battery, and it may be implemented in a form in which a gel polymer in the gel state is impregnated in the pores of the separator 114. The in-situ polymerization reaction proceeds through heat polymerization inside the flexible battery, the polymerization time takes about 20 minutes to 12 hours, and the heat polymerization may be performed at 40° C. to 90° C.

In this case, for the monomer for forming a gel polymer, any monomer may be used as long as a polymerization reaction proceeds by a polymerization initiator and a polymer forms a gel polymer. Examples thereof include monomers for methyl methacrylate (MMA), polyethylene oxide (PEO), polypropylene oxide (PPO), polyacrylonitrile (PAN), polyvinylidene fluoride (PVDF), polymethacrylate (PMA), polymethyl methacrylate (PMMA) or a polymer thereof, or a polyacrylate having two or more functional groups such as polyethylene glycol dimethacrylate and polyethylene glycol acrylate.

In addition, examples of the polymerization initiator include organic peroxides or hydroperoxides such as benzoyl peroxide, acetyl peroxide, dilauryl peroxide, di-tertbutylperoxide, cumyl hydroperoxide, hydrogen peroxide and the like, and azo compounds such as 2,2-azobis(2-cyanobutane), 2,2-azobis(methylbutyronitrile) and the like. The polymerization initiator may be decomposed by heat to form radicals and react with monomers by free radical polymerization to form a gel polymer electrolyte, that is, a gel polymer.

It is preferred that the monomer for forming a gel polymer is used at 1 to 10% by weight with respect to the organic electrolyte. When the content of the monomer is less than 1% by weight, it is difficult to form a gel-type electrolyte, and when the content thereof is more than 10% by weight, there is a problem in deterioration of a lifespan.

In addition, the polymerization initiator may be included at 0.01 to 5% by weight with respect to the monomer for forming a gel polymer.

Meanwhile, the flexible battery according to an exemplary embodiment of the present invention may have a resistance fluctuation rate of 5% or less, preferably 3% or less, and more preferably 1% or less, as measured by Measurement Method 1 below.

[Measurement Method 1]

In a fully charged flexible battery under an environment at a temperature of 25° C. and a humidity of 65%, a loading of 0.8 kN/24 cm² (=26 mm×91.5 mm) was applied by a hydraulic ram in a longitudinal direction of the battery to bend in the range of R25 to R38, and a loading under the same condition was applied in the opposite direction to bend in the range of R25 to R38 to measure resistance for 120 seconds, and then after measuring the resistance at 120 seconds after measurement, the resistance fluctuation rate was measured against resistance before bending.

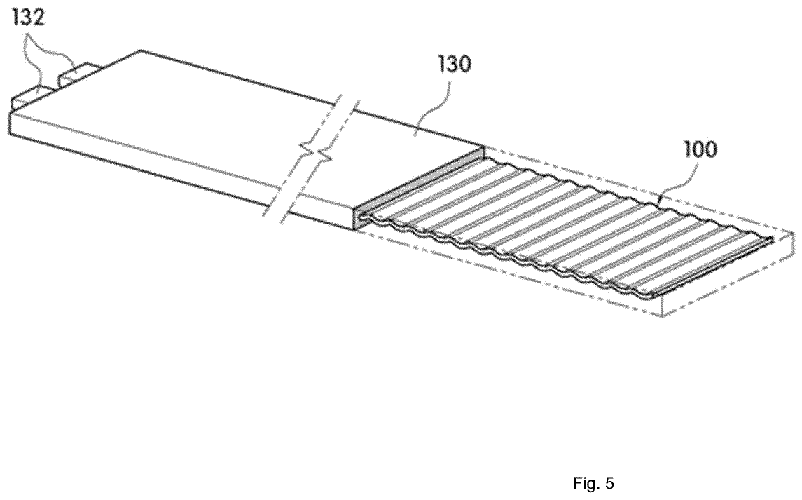

Meanwhile, the flexible battery 100 according to an exemplary embodiment of the present invention includes a housing 130 covering the surface of the exterior material 120 as illustrated in FIG. 5, and the housing 130 includes at least one terminal portion 132 for electric connection with a device to be charged to be implemented in a form of a supplementary battery. Herein, the housing 130 may be made of a rigid material such as plastic or metal, but may be used as a flexible soft material such as silicone or leather.

Herein, the supplementary battery is implemented as accessories such as bracelets and braces, a watch strap and the like to be used as fashion products if charging of the device to be charged is unnecessary and is electrically connected with the device to be charged through the terminal portion 132 if the charging of the device to be charged is necessary to charge a main battery of the device to be charged regardless of location.

Herein, it is illustrated that a pair of terminal portions 132 are included at an end of the housing 130, but is not limited thereto, and the terminal portion 131 may be provided at the side of the housing 130 and formed at various positions such as an upper surface or a lower surface of the housing. In addition, the terminal portion 132 may be provided in a separated form of a negative electrode terminal and a positive electrode terminal and provided in a combined form of the positive electrode and the negative electrode such as USB and the like.

In addition, the flexible battery of the present invention may be used as a main battery or a supplementary battery of an electric and/or electronic device requiring flexibility. For example, it is to be clear that the flexible battery according to the present invention may be widely used for electronic devices, etc. such as a watch strap of a smart watch, a flexible display and the like.

Meanwhile, the flexible battery 100 according to the present invention may be used without limitation, as long as it is a manufacturing method in which the electrode assembly 110 that can be commonly used in the related art is encapsulated by the exterior material 120 with an electrolyte.

In this case, the electrode assembly 110 is provided with a positive electrode 112 provided with a positive electrode current collector 112a in which part or all of at least one surface thereof is coated with a positive electrode active material 112b, and a negative electrode provided with a foil-type negative electrode current collector 116a in which part or all of at least one surface thereof is coated with a negative electrode active material 116b. Also, the electrode assembly 110 includes a pattern for contraction and relaxation along a longitudinal direction when bending.

Meanwhile, the flexible battery of the present invention has an effect that cracks are not generated in a current collector and/or an active material even when a pattern is formed with high strength in order to improve flexible characteristics. Moreover, as a predetermined pattern is formed, the occurrence of cracks can be prevented even when bending occurs, and deterioration of physical characteristics required as a battery may be prevented or minimized even when repeated bending occurs. The flexible battery of the present invention as above is applicable not only to wearable devices such as smart watches, watch straps and the like, but also to various electronic devices requiring that flexibility of the battery is secured such as rollable displays.

The present invention will be described in more detail through the following examples, but these examples do not limit the scope of the present invention, and it is to be construed to help the understanding of the present invention.

### EXAMPLE

First, a metal layer having a thickness of 30 μm and made of an aluminum material was prepared, and a first resin layer having a thickness of 40 μm and composed of casting polypropylene (CPP) was formed on one surface of the metal layer, and a second resin layer having a thickness of 10 μm and composed of a nylon film was formed on the other surface of the metal layer. In this case, an acid-modified polypropylene layer, in which the content of acrylic acid was contained at 6% by weight, was interposed between the first resin layer and the metal layer at 5 μm to manufacture an exterior material having a total thickness of 85 μm.

Next, in order to manufacture an electrode assembly, first, a positive electrode and a negative electrode were prepared. For the positive electrode, 1.04 parts by weight of spherical carbon black (Super-P, Timcal Ltd.) as a first conductive material, 0.52 parts by weight of graphite (KS-6, Timcal Ltd.) as a second conductive material and 2.6 parts by weight of PVDF were included, based on 100 parts by weight of lithium nickel cobalt manganese (NCM) having an average particle diameter of 10 μm as a positive electrode material, in a positive electrode current collector having a thickness of 20 μm and composed of an aluminum material. After forming a positive electrode mixture by coating a composition for forming a positive electrode active material having a solid content of 75% by weight and a viscosity of 12,000 csp at a thickness of 50 μm on both sides of the positive electrode current collector and drying for 1 minute at 150° C., a positive electrode current collector provided with the positive electrode mixture formed on both surfaces were vacuum dried for 12 hours at 130° C. to manufacture a positive electrode. In addition, for the negative electrode, 1.07 parts by weight of spherical carbon black (Super-P, Timcal Ltd.) as a first conductive material and 5.9 parts by weight of PVDF were included, based on 100 parts by weight of artificial graphite having an average particle diameter of 23 μm, in a negative electrode current collector having a thickness of 15 μm and made of a copper material. After forming a negative electrode mixture by coating a composition for forming a negative electrode active material having a solid content of 48% by weight and a viscosity of 10,000 csp to a thickness of 60 μm on both sides of the negative electrode current collector and drying for 1 minute at 150° C., a negative electrode current collector provided with the negative electrode mixture formed on both surfaces were vacuum dried for 12 hours at 100° C. to manufacture a negative electrode. Afterwards, a separator having a thickness of 20 μm and made of a PET/PEN material was prepared, and a positive electrode assembly, a separator and a negative electrode assembly were alternately laminated to manufacture an electrode assembly including 3 positive electrode assemblies, 8 separators and 4 negative electrode assemblies.

Afterwards, after the first resin layer of the prepared exterior material was folded to become the inner surface, the electrode assembly was disposed inside the exterior material such that the first resin layer of the folded exterior material contacted the electrode assembly, leaving only a part where an electrolyte could be injected, and it was heat-compressed for 10 seconds at a temperature of 150° C. Afterwards, a conventional electrolyte for a lithium-ion secondary battery was injected into the part, and the part injected with the electrolyte was heat-compressed for 10 seconds at a temperature of 150° C. to manufacture a battery. Afterwards, a flexible battery was manufactured by forming a wave pattern as shown in FIG. 4.

Detailed specifications for the manufactured flexible battery are shown in Table 1 below.

TABLE 1

| | |
|---|---|
| Section thickness (mm) | 2.1 ± 0.5 |
| Width (mm) | 26.0 ± 0.2 |
| Length (mm, excluding the external | 82.0 ± 0.5 |
| protruding terminal portion) | |
| Weight (g) | 5.2 ± 0.5 |
| Nominal capacity (mAh) | 135 |
| Nominal voltage (V) | 3.7 |

### Examples 2 to 11 and Comparative Examples 1 to 7

While manufactured by performing in the same manner as in Example 1, flexible batteries were manufactured by changing the vacuum drying conditions of a positive electrode current collector, the vacuum drying conditions of a negative electrode current collector, the solid content of the composition for forming a positive electrode active material, the solid content of the composition for forming a negative electrode active material and the like as shown in Tables 3 to 5 below.

### Experimental Example 1

1. Evaluation of Back Spring

With regard to the flexible batteries manufactured according to Examples and Comparative Examples, the layer thicknesses of a positive electrode mixture and a negative electrode mixture were measured before vacuum drying, respectively, and the layer thicknesses of a positive electrode mixture and a negative electrode mixture were measured after vacuum drying, and then the back spring was calculated according to Mathematical Formula 1 and Mathematical Formula 2 below. The results were shown in Tables 3 to 5.

Back spring (%)=((layer thickness of a positive electrode mixture after vacuum drying (μm)/layer thickness of a positive electrode mixture before vacuum drying (μm))−1)×100(%) [Mathematical Formula 1]

Back spring (%)=((layer thickness of a negative electrode mixture after vacuum drying (μm)/layer thickness of a negative electrode mixture before vacuum drying (μm))−1)×100(%) [Mathematical Formula 2]

2. Evaluation of Moisture Content

With regard to the flexible batteries manufactured according to Examples and Comparative Examples, the moisture contents of a negative electrode active material and a positive electrode active material were measured, respectively, and shown in Tables 3 to 5 below.

### Experimental Example 2

With regard to the flexible batteries manufactured according to Examples and Comparative Examples, the below physical properties were evaluated and shown in Tables 3 to 5.

1. Evaluation of Crack Occurrence

With regard to the flexible batteries manufactured according to Examples and Comparative Examples, the occurrence of cracks in the positive electrode active material and the negative electrode active material was evaluated at 120 magnification through Camscope. In this case, the occurrence of cracks was evaluated as the following. When cracks occurred, it was indicated as—∘, and when cracks did not occur, it was indicated as—x.

2. Evaluation of Physical Properties Related to Resistance

The flexible batteries manufactured according to Examples and Comparative Examples were fully charged under the conditions as in Table 2 below.

TABLE 2

| | | | |
|---|---|---|---|
| Charging | Normal Current | 0.2 | C |
| condition | Max. Current | 0.5 | C |
| | CC-CV | 4.2 | V |
| | Cut-Off | 0.05 | C |

2-1. Evaluation of Resistance

With regard to the flexible batteries manufactured according to Examples and Comparative Examples, resistance was measured using the AC-IR meter facility, and in this case, by setting the resistance value of the flexible battery according to Example 1 as 100, the ratios of the resistance values of other Examples and Comparative Examples were shown accordingly.

2-2. Evaluation of Resistance Fluctuation Rate after Unidirectional Bending

With regard to the flexible batteries manufactured according to Examples and Comparative Examples, in the fully charged flexible battery under an environment at a temperature of 25° C. and a humidity of 65%, a loading of 0.8 kN/24 cm² (=26 mm×91.5 mm) was applied by a hydraulic ram in a longitudinal direction of the battery to bend in the range of R25 to R38 and after straightening again, the resistance was measured for 120 seconds, and after measuring resistance at 120 seconds after measurement, the resistance fluctuation rate was measured against the resistance before bending.

2.2. Evaluation of Resistance Fluctuation Rate after Bidirectional Bending

With regard to the flexible batteries manufactured according to Examples and Comparative examples, in a fully charged flexible battery under an environment at a temperature of 25° C. and a humidity of 65%, a loading of 0.8 kN/24 cm² (=26 mm×91.5 mm) was applied by a hydraulic ram by folding at ½ point in a longitudinal direction of the battery to bend in the range of R25 to R38, and after straightening again, a loading under the same condition was applied in the opposite direction to bend in the range of R25 to R38 to measure resistance for 120 seconds, and then after measuring the resistance at 120 seconds after measurement, the resistance fluctuation rate was measured against the resistance before bending.

3. Evaluation of Durability

After performing 500 sets of bending and restoring to the original state as 1 set such that both ends of the flexible battery were in contact, the appearance of the battery was observed with an optical microscope to evaluate whether an abnormal appearance, such as the occurrence of leakage of an electrolyte, the occurrence of incontinence in the exterior material or the like, occurred, and when there was no abnormality as a result of evaluation, it was indicated as 0, and as the degree of abnormality was severe, it was indicated as 1 to 5.

4. Evaluation of Crack Occurrence after Evaluation of Durability

With regard to the flexible batteries manufactured according to Examples and Comparative Examples in which the evaluation of durability was performed, the occurrence of cracks in the positive electrode active material and the negative electrode active material was evaluated at 120 magnification through Camscope. In this case, crack occurrence was evaluated as the following. When cracks occurred, it was indicated as—∘, and when cracks did not occur, it was indicated as—x.

TABLE 3

| Classification | | Example 1 | Example 2 | Example 3 | Example 4 | Example 5 | Example 6 |
|---|---|---|---|---|---|---|---|
| Positive | Vacuum drying | 130 | 70 | 100 | 160 | 190 | 130 |
| electrode | temperature (° C.) | | | | | | |
| current | Vacuum drying | 12 | 12 | 12 | 12 | 12 | 6 |
| collector | time (hour) | | | | | | |
| Composition | Solid content (% | 75 | 75 | 75 | 75 | 75 | 75 |
| for forming | by weight) | | | | | | |
| positive | | | | | | | |
| electrode | | | | | | | |
| active | | | | | | | |
| material | | | | | | | |
| Negative | Vacuum drying | 100 | 40 | 70 | 130 | 160 | 100 |
| electrode | temperature (° C.) | | | | | | |
| current | Vacuum drying | 12 | 12 | 12 | 12 | 12 | 6 |
| collector | time (hour) | | | | | | |
| Composition | Solid content (% | 48 | 48 | 48 | 48 | 48 | 48 |
| for forming | by weight) | | | | | | |
| negative | | | | | | | |
| electrode | | | | | | | |
| active material | | | | | | | |
| Positive | Back spring (%) | 1.5 | 0.9 | 1.2 | 2.3 | 3.1 | 0.8 |
| electrode | | | | | | | |
| mixture | | | | | | | |
| Negative | Back spring (%) | 2.5 | 1.8 | 2.3 | 3.3 | 4.1 | 1.9 |
| electrode | | | | | | | |
| mixture | | | | | | | |
| Positive | Moisture content | 250 | 481 | 344 | 235 | 220 | 490 |
| electrode | (ppm) | | | | | | |
| active material | | | | | | | |
| Negative | Moisture content | 50 | 192 | 86 | 43 | 39 | 194 |
| electrode | (ppm) | | | | | | |
| active material | | | | | | | |

| | | | | | | |
|---|---|---|---|---|---|---|
| Evaluation of crack occurrence | x | x | x | x | x | x |
| Evaluation of resistance | 100 | 133 | 104 | 102 | 106 | 130 |
| Rate of resistance fluctuation after | 0 | 0 | 0 | 0 | 2 | 0 |
| unidirectional bending (%) | | | | | | |
| Rate of resistance fluctuation after | 0 | 0 | 0 | 0 | 70 | 0 |
| bidirectional bending (%) | | | | | | |
| Evaluation of durability | 0 | 1 | 0 | 0 | 1 | 1 |
| Evaluation of crack occurrence | x | x | x | x | ∘ | x |
| after evaluation of durability | | | | | | |

TABLE 4

| | | | | | | | Comparative |
|---|---|---|---|---|---|---|---|
| Classification | | Example 7 | Example 8 | Example 9 | Example 10 | Example 11 | Example 1 |
| Positive | Vacuum drying | 130 | 130 | 130 | 130 | 130 | 70 |
| electrode | temperature (° C.) | | | | | | |
| current | Vacuum drying | 9 | 15 | 18 | 12 | 12 | 6 |
| collector | time (hour) | | | | | | |
| Composition | Solid content (% | 75 | 75 | 75 | 95 | 75 | 75 |
| for forming | by weight) | | | | | | |
| positive | | | | | | | |
| electrode | | | | | | | |
| active material | | | | | | | |
| Negative | Vacuum drying | 100 | 100 | 100 | 100 | 100 | 100 |
| electrode | temperature (° C.) | | | | | | |
| current | Vacuum drying | 9 | 15 | 18 | 12 | 12 | 12 |
| collector | time (hour) | | | | | | |
| Composition | Solid content (% | 48 | 48 | 48 | 48 | 80 | 48 |
| for forming | by weight) | | | | | | |
| negative | | | | | | | |
| electrode | | | | | | | |
| active material | | | | | | | |
| Positive | Back spring (%) | 1.3 | 2.2 | 3.1 | 1.1 | 1.5 | 0.6 |
| electrode | | | | | | | |
| mixture | | | | | | | |
| Negative | Back spring (%) | 2.3 | 3.3 | 4.2 | 2.5 | 2.2 | 2.5 |
| electrode | | | | | | | |
| mixture | | | | | | | |
| Positive | Moisture content | 349 | 236 | 218 | 230 | 250 | 597 |
| electrode | (ppm) | | | | | | |
| active material | | | | | | | |
| Negative | Moisture content | 88 | 44 | 38 | 50 | 42 | 50 |
| electrode | (ppm)) | | | | | | |
| active material | | | | | | | |

| | | | | | | |
|---|---|---|---|---|---|---|
| Evaluation of crack occurrence | x | x | x | x | x | x |
| Evaluation of resistance | 103 | 102 | 106 | 101 | 102 | 164 |
| Rate of resistance fluctuation after | 0 | 0 | 3 | 4 | 4 | 2 |
| unidirectional bending (%) | | | | | | |
| Rate of resistance fluctuation after | 0 | 0 | 68 | 12 | 13 | 11 |
| bidirectional bending (%) | | | | | | |
| Evaluation of durability | 0 | 0 | 1 | 3 | 3 | 2 |
| Evaluation of crack occurrence | x | x | ∘ | ∘ | ∘ | x |
| after evaluation of durability | | | | | | |

TABLE 5

| | | Comparative | Comparative | Comparative | Comparative | Comparative | Comparative |
|---|---|---|---|---|---|---|---|
| Classification | | Example 2 | Example 3 | Example 4 | Example 5 | Example 6 | Example 7 |
| Positive | Vacuum drying | 190 | 130 | 130 | 130 | 130 | 130 |
| electrode | temperature (° C.) | | | | | | |
| current | Vacuum drying | 18 | 12 | 12 | 12 | 12 | 12 |
| collector | time (hour) | | | | | | |
| Composition | Solid content (% | 75 | 75 | 75 | 50 | 75 | 50 |
| for forming | by weight) | | | | | | |
| positive | | | | | | | |
| electrode | | | | | | | |
| active material | | | | | | | |
| Negative | Vacuum drying | 100 | 40 | 160 | 100 | 100 | 100 |
| electrode | temperature (° C.) | | | | | | |
| current | Vacuum drying | 12 | 6 | 18 | 12 | 12 | 12 |
| collector | time (hour) | | | | | | |
| Composition | Solid content (% | 48 | 48 | 48 | 48 | 20 | 20 |
| for forming | by weight) | | | | | | |
| negative | | | | | | | |
| electrode | | | | | | | |
| active material | | | | | | | |
| Positive | Back spring (%) | 4 | 1.5 | 1.5 | 5 | 1.5 | 5 |
| electrode | | | | | | | |
| mixture | | | | | | | |
| Negative | Back spring (%) | 2.5 | 1.6 | 4.9 | 2.5 | 5 | 5 |
| electrode | | | | | | | |
| mixture | | | | | | | |
| Positive | Moisture content | 190 | 250 | 250 | 282 | 250 | 282 |
| electrode | (ppm) | | | | | | |
| active material | | | | | | | |
| Negative | Moisture content | 50 | 299 | 35 | 50 | 63 | 63 |
| electrode | (ppm)) | | | | | | |
| active material | | | | | | | |

| | | | | | | |
|---|---|---|---|---|---|---|
| Evaluation of crack occurrence | ∘ | x | ∘ | ∘ | ∘ | ∘ |
| Evaluation of resistance | 147 | 167 | 144 | 151 | 149 | 166 |
| Rate of resistance fluctuation after | 41 | 5 | 48 | 48 | 52 | 64 |
| unidirectional bending (%) | | | | | | |
| Rate of resistance fluctuation after | 97 | 14 | 109 | 113 | 111 | 127 |
| bidirectional bending (%) | | | | | | |
| Evaluation of durability | 3 | 2 | 3 | 3 | 3 | 4 |
| Evaluation of crack occurrence | ∘ | x | ∘ | ∘ | ∘ | ∘ |
| after evaluation of durability | | | | | | |

As can be seen in Tables 3 to 5, it was confirmed that Examples 1, 3, 4, 7 and 8, which satisfied all of the vacuum drying condition of a positive electrode current collector, the vacuum drying condition of a negative electrode current collector, the solid content of the composition for forming a positive electrode active material, the solid content of the composition for forming a negative electrode active material and the like according to the present invention, exhibited all of the effects of no spot occurrence, low resistance, low rate of resistance fluctuation after unidirectional and bidirectional bending, excellent durability and no crack occurrence after the evaluation of durability, compared to Examples 2, 5, 6 and 9 to 11 and Comparative Examples 1 to 7 in which any one of the above was omitted.

The flexible battery of the present invention has an effect in which cracks and/or peeling of an active material do not occur during pattern formation as the back spring phenomenon is suppressed, and accordingly, performance reduction due to a decrease in capacity, an increase in resistance and an internal short circuit and the like does not occur.

Moreover, the occurrence of cracks can be prevented even if bending occurs as a predetermined pattern is formed, and deterioration of physical characteristics that a battery is required to exhibit can be prevented or minimized.

The flexible battery of the present invention as above is applicable not only to wearable devices such as smart watches, watch straps and the like, but also to various electronic devices such as rollable displays, etc., which require battery flexibility to be secured.

Although exemplary embodiments of the present invention are described above, the spirit of the present invention is not limited to the exemplary embodiments presented in the present specification, and although those skilled in the art may provide other exemplary embodiments through the addition, change, or removal of components within the scope of the same spirit of the present invention, such embodiments are also included in the scope of the spirit of the present invention.

1. A method for manufacturing a flexible battery, wherein, in a method for manufacturing a flexible battery in which an electrode assembly is encapsulated by an exterior material with an electrolyte, the electrode assembly is manufactured by comprising the steps of:
forming a positive electrode mixture by coating and drying a composition for forming a positive electrode active material on part or all of at least one surface of a positive electrode current collector;
vacuum drying the positive electrode current collector to manufacture a positive electrode;
forming a negative electrode mixture by coating and drying a composition for forming a negative electrode active material on part or all of at least one surface of a negative electrode current collector;
vacuum drying the negative electrode current collector to manufacture a negative electrode; and
laminating by interposing a separator between the positive electrode and the negative electrode,
wherein the positive electrode mixture has a back spring calculated according to Mathematical Formula 1 below of 3.5% or less,
wherein the negative electrode mixture has a back spring calculated according to Mathematical Formula 2 below of 4.5% or less:
Back spring (%)=((layer thickness of a positive electrode mixture after vacuum drying (μm)/layer thickness of a positive electrode mixture before vacuum drying (μm))−1)×100(%) [Mathematical Formula 1]
Back spring (%)=((layer thickness of a negative electrode mixture after vacuum drying (μm)/layer thickness of a negative electrode mixture before vacuum drying (μm))−1)×100(%) [Mathematical Formula 2].

2. The method of claim 1, wherein the composition for forming a positive electrode active material has a solid content of 60 to 90% by weight,
wherein the vacuum drying of a positive electrode current collector is performed at a temperature of 90 to 170° C. for 8 to 16 hours.

3. The method of claim 1, wherein the composition for forming a positive electrode active material comprises 0.5 to 1.5 parts by weight of a first conductive material, 0.1 to 1 part by weight of a second conductive material and 1 to 4 parts by weight of PVDF based on 100 parts by weight of a positive electrode material.

4. The method of claim 1, wherein the composition for forming a negative electrode active material has a solid content of 30 to 65% by weight,
wherein the vacuum drying of a negative electrode current collector is performed at a temperature of 60 to 140° C. for 8 to 16 hours.

5. The method of claim 1, wherein the composition for forming a negative electrode active material comprises 0.55 to 1.6 parts by weight of a first conductive material and 2.5 to 9 parts by weight of PVDF based on 100 parts by weight of a negative electrode material.

6. The method of claim 3, wherein the first conductive material comprises spherical carbon black,
wherein the second conductive material comprises graphite.

7. The method of claim 5, wherein the first conductive material comprises spherical carbon black.

8. The method of claim 1, further comprising forming a pattern for contraction and relaxation in a longitudinal direction when bending.

9. A flexible battery, comprising:
an electrode assembly provided with a positive electrode in which a positive electrode active material is coated on part or all of at least one surface of a positive electrode current collector, a negative electrode in which a negative electrode active material is coated on part or all of at least one surface of a negative electrode current collector, and a separator disposed between the positive electrode and the negative electrode;
an electrolyte; and
an exterior material encapsulating the electrode assembly with the electrolyte,
wherein the negative electrode active material has a moisture content of 200 ppm or less,
wherein the positive electrode active material has a moisture content of 500 ppm or less.

10. The flexible battery of claim 9, wherein a resistance fluctuation rate measured by Measurement Method 1 below is 5% or less:
[Measurement Method 1]
In a fully charged flexible battery, resistance is measured by bending in a longitudinal direction of the battery and bending in the opposite direction, and then the resistance fluctuation rate is measured against resistance before bending.

11. The flexible battery of claim 9, wherein the positive electrode active material has a layer thickness of 40 to 60 μm,
wherein the negative electrode active material has a layer thickness of 50 to 75 μm.

12. The flexible battery of claim 9, wherein the positive electrode active material is formed by a composition for forming a positive electrode active material comprising a positive electrode material, a first conductive material, a second conductive material and PVDF,
wherein the positive electrode material has an average particle diameter of 3 to 20 μm.

13. The flexible battery of claim 9, wherein the negative electrode active material is formed by a composition for forming a negative electrode active material comprising a negative electrode material, a first conductive material and PVDF,
wherein the negative electrode material has an average particle diameter of 8 to 40 μm.

14. The flexible battery of claim 9, wherein the electrode assembly comprises a pattern for contraction and relaxation in a longitudinal direction when bending.

15. A supplementary battery, comprising:
the flexible battery according to claim 9; and
a soft housing covering the surface of the exterior material,
wherein the housing is provided with at least one terminal portion for electrical connection with a device to be charged.
